(19) United States
(12) Patent Application Publication
(10) Pub. No.: US 2024/0152085 A1
(43) Pub. Date: May 9, 2024

(54) LUBRICANT LEVELLING BLADE, PROCESS CARTRIDGE, IMAGE FORMING APPARATUS, AND IMAGE FORMING METHOD

(71) Applicants: Keiichiro JURI, Kanagawa (JP); Masahiro OHMORI, Kanagawa (JP)

(72) Inventors: Keiichiro JURI, Kanagawa (JP); Masahiro OHMORI, Kanagawa (JP)

(21) Appl. No.: 18/284,296

(22) PCT Filed: Feb. 21, 2022
(86) PCT No.: PCT/JP2022/007057

§ 371 Date: Sep. 27, 2023

(30) Foreign Application Priority Data
Apr. 1, 2021 (JP) 2021-063007

(51) Int. Cl. G03G 21/00

(52) U.S. Cl. CPC G03G 21/0017; G03G 21/0094

(57) ABSTRACT

Provided is a lubricant levelling blade (104) including an elastic member (1042) configured to contact a surface of an image bearer (3) to apply a lubricant to the surface of the image bearer. A contact surface (104c) of the elastic member with the image bearer is a polyurethane elastomer. A Martens hardness HM of the contact surface of the elastic member with the image bearer is 1.5 N/mm² or higher but 30.0 N/mm² or lower.

### TECHNICAL FIELD

The present disclosure relates to a lubricant levelling blade, a process cartridge, an image forming apparatus, and an image forming method.

### BACKGROUND ART

Image forming apparatus relying on an electrophotographic system is generally provided with a cleaning device configured to clean an image bearer surface for removing the residual toner on the image bearer surface after transfer to repeatedly use the image bearer surface for image formation. The cleaning device that is typically used is a cleaning blade formed of an elastic material such as polyurethane rubber by virtue of a simplified structure thereof and excellence in toner removing performance. Known image forming apparatuses are provided with a lubricant feeding device configured to feed a lubricant such as a fatty acid metal salt to an image bearer surface for reducing the friction coefficient between the cleaning blade and the image bearer surface. In such image forming apparatuses, when the amount of the lubricant fed to the image bearer surface is too small, the friction coefficient therebetween cannot be reduced enough to sufficiently prevent failures due to high friction coefficient (e.g., rolling up of the cleaning blade and shorter lifetime of the image bearer). Meanwhile, when the amount of the lubricant fed to the image bearer surface is too large, an increased amount of the lubricant adheres to various members and devices surrounding the image bearer to cause considerable failures due to adhesion of the lubricant (e.g., formation of an abnormal image due to adhesion of the lubricant to, for example, a charging member and a developer bearer). In the image forming apparatuses provided with a member for feeding the lubricant to the image bearer surface, it is desirable to control the amount of the lubricant fed to the image bearer surface to be an appropriate amount.

In some of the image forming apparatuses, the lubricant is fed to the image bearer surface upstream a site at which the cleaning blade contacts the image bearer surface in the surface-moving direction. In this structure, the cleaning blade has a function of levelling the lubricant fed to the image bearer surface by, for example, extending the lubricant. It is therefore possible to level the lubricant fed to the image bearer surface to some extents without providing a lubricant levelling member for levelling the lubricant in addition to the cleaning blade. In this structure, however, the lubricant enters the cleaning blade contact site together with the residual toner after transfer. This causes a difference in the amount of the lubricant from region to region depending on the presence or absence of the residual toner after transfer, which makes impossible to sufficiently level the lubricant. In this case, the image bearer surface has sites where the amount of the lubricant is too large and sites where the amount of the lubricant is too small. As a result, the above-described failures may occur locally. Also in the above structure, the lubricant adheres to the residual toner after transfer and is removed with the toner. In this case, the amount of the lubricant removed is difficult to accurately determine. Thus, it is difficult to control the amount of the lubricant that is to be fed or consumed, resulting in higher possibility of occurrence of the above-described failures.

For example, disclosed is an image forming apparatus provided with a lubricant feeding unit downstream the cleaning blade contact site with the image bearer surface in the surface-moving direction and with a lubricant levelling blade configured to level the lubricant downstream the lubricant feeding unit. In such an image forming apparatus, the image bearer surface to be fed with the lubricant is already cleaned, and the lubricant fed to the image bearer surface can be sufficiently levelled with the lubricant levelling blade. It is also possible to prevent an event that the lubricant adheres to the residual toner after transfer and is removed together with the toner. This makes it easier to control the amount of the lubricant that is to be fed or consumed. The lubricant levelling blade described in PTL 1 levels the lubricant fed to the image bearer surface by being contacted at the ridge portion thereof with the image bearer surface so that the ridge portion crosses the surface-moving direction of the image bearer surface. This lubricant levelling blade is a right angle blade in which a blade corner angle is the right angle that is formed between two faces respectively facing the image bearer surface upstream and downstream the image bearer surface-moving direction with the ridge portion that is to contact the image bearer surface being sandwiched by the two faces.

Recent image forming apparatuses are required to be free from maintenance for a long period of time. It is desirable to maintain the functions of the lubricant levelling blade constant over time from the initial state. In order to maintain the functions of the lubricant levelling blade, it is necessary to reduce the amount of abrasion over time at the ridge portion of lubricant levelling blade that is to contact the image bearer surface.

PTLs 2 and 3 use, as a lubricant levelling blade, an obtuse angle blade in which a blade corner angle is an obtuse angle that is formed between two faces respectively facing the image bearer surface upstream and downstream the image bearer surface-moving direction with the ridge portion that is to contact the image bearer surface being sandwiched by the two faces.

The existing lubricant levelling blades having an obtuse blade corner angle indeed reaches a certain level in terms of applying the lubricant on the image bearer surface while preventing the contact portion thereof from rolling up and deforming. However, they do not satisfactorily respond to high-speed, high-quality image formation in recent image forming apparatuses.

### CITATION LIST

### Patent Literature

PTL 1: Japanese Unexamined Patent Application Publication No. 2000-330443
PTL 2: Japanese Unexamined Patent Application Publication No. 2008-276125
PTL 3: Japanese Patent No. 5505784

### SUMMARY OF INVENTION

### Technical Problem

The present disclosure has an object to provide a lubricant levelling blade that can respond to high-speed, high-quality image formation and is excellent in durability in a low-temperature environment.

### Solution to Problem

According to one aspect of the present disclosure, a lubricant levelling blade includes an elastic member configured to contact a surface of an image bearer to apply a lubricant to the surface of the image bearer. A contact surface of the elastic member with the image bearer is a polyurethane elastomer. A Martens hardness HM of the contact surface of the elastic member with the image bearer is 1.5 N/mm² or higher but 30.0 N/mm² or lower.

### Advantageous Effects of Invention

The present disclosure can provide a lubricant levelling blade that can respond to high-speed, high-quality image formation and is excellent in durability in a low-temperature environment.

### BRIEF DESCRIPTION OF DRAWINGS

FIG. 1 is a schematic view illustrating one example of a lubricant levelling blade according to the present disclosure.

FIG. 2 is a schematic view illustrating one example of a state where a lubricant levelling blade according to the present disclosure is disposed in contact with an image bearer.

FIG. 3 is a schematic structural view illustrating one example of an image forming apparatus according to the present disclosure.

FIG. 4 is a structural view illustrating one example of a schematic structure of one image forming unit.

FIG. 5 is an explanatory view for one example of an angle of a leading end ridge portion.

### DESCRIPTION OF EMBODIMENTS

Embodiments of the present disclosure will be described. The lubricant levelling blade according to the present disclosure has the following features.

Specifically, the lubricant levelling blade includes an elastic member configured to contact a surface of an image bearer to apply a lubricant to the surface of the image bearer. A contact surface of the elastic member with the image bearer is a polyurethane elastomer. A Martens hardness HM of the contact surface of the elastic member with the image bearer is high; i.e., 1.5 N/mm² or higher but 30.0 N/mm² or lower. Thus, the behaviors of the leading end ridge portion are stabilized, and further the leading end ridge portion can be prevented from abrasion due to rubbing on the image bearer. This makes it possible to prevent formation of an abnormal image due to uneven application of the lubricant in the sub-scanning direction, and respond to high-speed, high-quality image formation.

The polyurethane elastomer is highly durable to crack formation in a low-temperature environment, which is a common adverse phenomenon of a high-hardness blade.

The features of the lubricant levelling blade of the present disclosure will be described in detail with reference to the drawings.

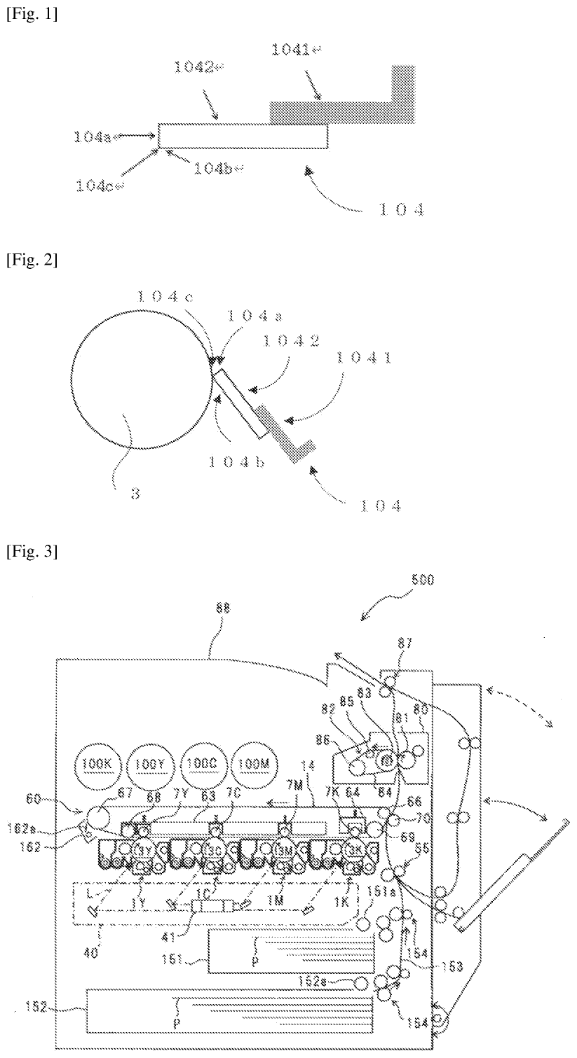

FIG. 1 is a schematic view of a lubricant levelling blade 104. As illustrated in FIG. 1, the lubricant levelling blade 104 includes a flat-plate supporting member 1041 formed of a rigid material such as a metal and hard plastics, and a flat-plate elastic member 1042. The elastic member 1042 is bonded to a side of one end of the supporting member 1041 via, for example, an adhesive. The other end of the supporting member 1041 is cantilevered on the casing of a lubricant applicator.

As illustrated in FIGS. 1 and 2, the lubricant levelling blade 104 includes the supporting member 1041 and the flat-plate elastic member 1042, where one end of the flat-plate elastic member 1042 is bonded to the supporting member 1041 and the other end thereof has a free end portion having a predetermined length. A contact surface 104c, which is an end of the elastic member 1042 on the free end side thereof, is disposed so as to contact the surface of an image bearer 3 along the longer direction of the elastic member 1042. Also, a blade leading end surface 104a and a blade bottom surface 104b are illustrated. The contact surface 104c with a member to be cleaned by the elastic member is also referred to as a leading end ridge portion.

The elastic member 1042 of the lubricant levelling blade 104 may have a monolayered structure or a multilayered structure. The multilayered structure can have layers with separate functions, which is advantageous. For example, when the elastic member 1042 is formed to have a multilayered structure of a low-hardness base layer and a surface layer including the leading end ridge portion, even if the surface layer has a high hardness, the elastic member 1042 can follow the image bearer by virtue of the low hardness of the base layer.

<Image Bearer>

The material, shape, structure, size, etc. of the image bearer are not particularly limited and may be appropriately selected depending on the intended purpose. The material of the image bearer is not particularly limited and may be appropriately selected depending on the intended purpose. Examples of the material include metals, plastics, and ceramics.

<Lubricant>

The lubricant that is preferably used is powder of a lamellar crystal such as zinc stearate. The lamellar crystal has a layered structure that is formed through self-assembly of amphiphilic molecules. By application of a shearing force, the lamellar crystal splits easily to slide along the interlayer. This action is believed to be effective to lowering the friction coefficient. The lubricant that is usable may be any of other substances such as various fatty acid salts, wax, and silicone oil.

Examples of the fatty acid include undecylic acid, lauric acid, tridecylic acid, myristic acid, palmitic acid, pentadecylic acid, stearic acid, heptadecylic acid, arachidic acid, montanic acid, oleic acid, arachidonic acid, caprylic acid, capric acid, and caproic acid. Examples of metal salts thereof include salts thereof with metals such as zinc, iron, copper, magnesium, aluminum, and calcium.

<Supporting Member>

The shape, size, material, etc. of the supporting member are not particularly limited and may be appropriately selected depending on the intended purpose. Examples of the shape of the supporting member include a flat plate, a strip, and a sheet. The size of the supporting member is not particularly limited and may be appropriately selected depending on the size of the image bearer.

Examples of the supporting member include metals, plastics, and ceramics. Of these, a metal place is preferable in terms of strength, and a sheet steel of, for example, stainless steel, an aluminum plate, a phosphor bronze plate are particularly preferable.

<Elastic Member>

The contact surface of the elastic member with the image bearer is a polyurethane elastomer.

The Martens hardness HM of the contact surface of the elastic member with the image bearer is 1.5 N/mm² or higher but 30.0 N/mm² or lower, preferably 5 N/mm² or higher but 20 N/mm² or lower, and further preferably 7.5 N/mm² or higher but 15 N/mm² or lower.

The Martens hardness (HM) was measured in compliant with ISO14577 using nanoindenter ENT-3100 obtained from ELIONIX INC. by indenting a Berkovich indenter at a load of 1000 μN for 10 seconds, retaining for 5 seconds, and pulling it off at the same rate of loading for 10 seconds.

The measurement position for the Martens hardness was a position 20 μm apart from the leading end ridge portion of the contact surface of an elastic member that had been obtained by forming a molded sheet into a blade.

When the Martens hardness HM of the contact surface of the elastic member with the image bearer is lower than 1.5 N/mm², the behaviors of the leading end ridge portion are unstable, leading to reduction of the function of applying the lubricant. When the Martens hardness HM is higher than 30.0 N/mm², cutting is difficult to perform due to too high hardness, causing difficulty in forming an edge.

The Martens hardness HM of the elastic member is adjustable by adjusting the for-mulation design of the polyurethane elastomer and the molding temperature.

The shape, size, structure, etc. of the elastic member are not particularly limited and may be appropriately selected depending on the intended purpose. Examples of the shape of the elastic member include a flat plate, a strip, and a sheet. The size of the elastic member is not particularly limited and may be appropriately selected depending on the size of the image bearer.

The angle of the leading end ridge portion of the elastic member is preferably from 90 degrees through 140 degrees. When the angle of the leading end ridge portion is an obtuse angle within the above range, the blade leading end surface 104a can be prevented from being entrained, which makes it possible to stably apply the lubricant. When the angle of the leading end ridge portion is 140 degrees or lower, the edge exhibits better effects, leading to improvement in the function of applying the lubricant.

As used herein, the angle of the leading end ridge portion is, as illustrated in FIG. 5, an angle θ of a blade corner angle formed between two faces respectively facing the image bearer surface upstream and downstream the image bearer surface-moving direction with the leading end ridge portion 104c being sandwiched by the two faces.

The polyurethane elastomer of the elastic member is not particularly limited and may be appropriately selected depending on the intended purpose. As a result of intensive studies, it is found that preferable is a polyurethane elastomer containing a prepolymer and a urea bond formed of an aromatic diamine, where the prepolymer is obtained by substituting a hydroxyl group of a polyol with difunctional isocyanate.

As a result of intensive studies, it is found that the polyol component of the polyurethane elastomer is preferably polyether polyol. Examples of the polyether polyol include polytetramethylene ether glycol, polyoxypropylene triol, polyethylene glycol, polypropylene glycol, and polyethylene glycol-polypropylene glycol block copolymers. As the polyether polyol, polytetramethylene ether glycol (PTMG) is preferably used.

The number average molecular weight of the polytetramethylene ether glycol is preferably 850 or higher but 2000 or lower.

When the polyether polyol is the polytetramethylene ether glycol having a number average molecular weight of 850 or higher but 2000 or lower, the polyurethane elastomer can exhibit elastic functions while having a relatively high Martens hardness HM of 1.5 N/mm² or higher but 30.0 N/mm² or lower.

The number average molecular weight is a value obtained by measuring a THF-soluble component through GPC under the following conditions.

GPC apparatus: HLC-8120GPC, obtained from TOSOH CORPORATION

COLUMN: TSK-GEL, obtained from TOSOH CORPORATION

Solvent: THF

Solvent concentration: 0.5% by mass

Flow rate: 1.0 ml/min

The difunctional isocyanate is not particularly limited and may be appropriately selected depending on the intended purpose. Examples of the difunctional isocyanate include dicyclohexylmethane 4,4′-diisocyanate (hydrogenated MDI), methylene diphenyl diisocyanate (MDI), tolylene diisocyanate (TDI), xylylene diisocyanate (XDI), naphthylene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). These may be used alone or in combination. Dicyclohexylmethane 4,4′-diisocyanate (hydrogenated MDI) is preferably used.

Examples of the aromatic diamine include diethylmethylbenzene diamine, 4,4′-diaminodiphenyl ether, 2,2′-bis[4-(4-aminophenoxy)phenyl]propane, bis[4-(4-aminophenoxy)phenyl]sulfone, 1,3-bis(4-aminophenoxy)benzene, 4,4′-diaminodiphenylsulfone, and 4,4′-methylene-bis(2-chloroaniline). Diethylmethylbenzene diamine is preferable.

The polyurethane elastomer can be obtained in the following manner, for example. Specifically, a polyurethane prepolymer is prepared by substituting a hydroxyl group of a polyether polyol with difunctional isocyanate. An aromatic diamine is added to the polyurethane prepolymer. An NCO group of the prepolymer and an amino group of the aromatic diamine serving as a curing agent are allowed to react to form a urea bond.

The polyurethane prepolymer, which is prepared by substituting a hydroxyl group of a polyether polyol with difunctional isocyanate, preferably has an NCO % of from 3.5 through 11.6% as determined by the neutralization titration method standardized in JIS K 6806, and more preferably has the NCO % of from 5.0 through 6.0%. The aromatic diamine is added preferably in an amount of from 7.0 through 11.0 parts by mass and more preferably in an amount of from 10.5 through 10.8 parts by mass, relative to 100 parts by mass of the prepolymer.

A glass transition temperature of the polyurethane elastomer is preferably −30 degrees Celsius or higher but 0 degrees Celsius or lower. When the glass transition temperature is low; i.e., −30 degrees Celsius or higher but 0 degrees Celsius or lower, the functions of the blade at low temperatures remain unchanged from those at normal temperatures, and the blade is more resistant to cracking in a low-temperature environment. Therefore, superior properties can be secured for cracking at low temperatures, which is a typical failure on the high-hardness side.

The glass transition temperature was measured using the DMA method. Specifically, DMS6100 obtained from Hitachi High-Tech Corporation was used to make measurement at a frequency of 10 Hz, and the tans peak temperature was read and defined as the glass transition temperature.

The material of the base of the elastic member is not particularly limited and may be appropriately selected depending on the intended purpose. In terms of easily obtaining high elasticity, polyurethane rubber, polyurethane elastomer, etc. are suitable.

The base of the elastic member is not particularly limited and may be appropriately selected depending on the intended purpose. The base is produced in the following manner, for example. Specifically, a polyurethane prepolymer is prepared using a polyol compound and a polyisocyanate compound. A curing agent and an optional curing catalyst are added to the polyurethane prepolymer, and the polyurethane prepolymer is allowed to undergo crosslinking in a predetermined mold. The crosslinked product is subjected to post-crosslinking in a furnace. The resultant is molded into a sheet through centrifugal molding. The sheet is left to stand at normal temperature, followed by aging. The resultant is cut into a flat plate having predetermined dimensions.

The polyol compound is not particularly limited and may be appropriately selected depending on the intended purpose. Examples of the polyol compound include high-molecular-weight polyols and low-molecular-weight polyols.

Examples of the high-molecular-weight polyols include: polyester polyols which are condensates between alkylene glycols and aliphatic dibasic acids; polyester-based polyols such as polyester polyols between alkylene glycols and adipic acid, including ethylene adipate ester polyol, butylene adipate ester polyol, hexylene adipate ester polyol, ethylene propylene adipate ester polyol, ethylene butylene adipate ester polyol, and ethylene neopentylene adipate ester polyol; polycaprolactone-based polyols such as polycaprolactone ester polyol obtained through ring-opening polymerization of caprolactone; and polyether polyols such as poly(oxytetramethylene)glycol and poly(oxypropylene)glycol. These may be used alone or in combination.

Examples of the low-molecular-weight polyols include: divalent alcohols such as 1,4-butanediol, ethylene glycol, neopentyl glycol, hydroquinone-bis(2-hydroxyethyl)ether, 3,3′-dichloro-4,4′-diaminodiphenylmethane, and 4,4′-diaminodiphenylmethane; and tri- or higher valent polyvalent alcohols such as 1,1,1-trimethylolpropane, glycerin, 1,2,6-hexanetriol, 1,2,4-butanetriol, trimethylolethane, 1,1,1-tris(hydroxyethoxymethyl)propane, diglycerin, and pentaerythritol. These may be used alone or in combination.

The polyisocyanate compound is not particularly limited and may be appropriately selected depending on the intended purpose. Examples of the polyisocyanate compound include methylene diphenyl diisocyanate (MDI), tolylene diisocyanate (TDI), xylylene diisocyanate (XDI), naphthylene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). These may be used alone or in combination.

The curing catalyst is not particularly limited and may be appropriately selected depending on the intended purpose. Examples of the curing catalyst include 2-methylimidazole and 1,2-dimethylimidazole.

The amount of the curing catalyst is not particularly limited and may be appropriately selected depending on the intended purpose. The amount thereof is preferably from 0.01% by mass through 0.5% by mass and more preferably from 0.05% by mass through 0.3% by mass.

The JIS-A hardness of the base of the elastic member is preferably from 55 degrees through 83 degrees. When the JIS-A hardness is 55 degrees or higher, the linear pressure of the blade is easy to obtain, and the area of the contact potion with the image bearer does not easily become larger, so that the behaviors of the leading end portion of the blade are stabilized. When the JIS-A hardness is 83 degrees or lower, cracks do not easily occur, which would occur when the base is too hard.

The base of the elastic member is not particularly limited and may be appropriately selected depending on the intended purpose. In terms of being able to achieve both satisfactory abrasion resistance and satisfactory followability, it is preferable to use a stack formed by monolithically molding two or more kinds of rubber having different values of JIS-A hardness. Here, the JIS-A hardness of the base of the elastic member can be measured by using, for example, micro durometer MD-1 obtained from KOBUNSHI KEIKI CO., LTD.

The modulus of repulsion elasticity of the base of the elastic member in compliant with the JIS K6255 standard is not particularly limited and may be appropriately selected depending on the intended purpose. The modulus of repulsion elasticity thereof is preferably 36% or higher but 73% or lower at 23 degrees Celsius and more preferably from 36% through 56%. When the modulus of repulsion elasticity is 36% or higher, the elastic member is flexible as a whole and can follow runout and roughness of the image bearer, so that cleaning failures do not occur. When the modulus of repulsion elasticity is 73% or lower, blade squeak does not occur, which would occur when repulsion is too strong.

Here, the modulus of repulsion elasticity of the base of the elastic member is, for example, in compliant with the JIS K6255 standard, and can be measured at 23 degrees Celsius using No. 221 Resilience Tester obtained from Toyo Seiki Seisaku-sho, Ltd.

The average thickness of the elastic member is not particularly limited and may be appropriately selected depending on the intended purpose. The average thickness thereof is preferably 1.0 mm or larger but 1.5 mm or smaller.

(Image Forming Apparatus and Image Forming Method)

An image forming apparatus of the present disclosure includes an image bearer, a lubricant applying unit configured to apply a lubricant to a surface of the image bearer, a charging unit configured to charge the surface of the image bearer, an exposing unit configured to expose the image bearer charged to light to form an electrostatic latent image, a developing unit configured to develop the electrostatic latent image with a toner to form a visible image, a transfer unit configured to transfer the visible image to a recording medium, a fixing unit configured to fix the visible image transferred to the recording medium, and a cleaning unit configured to remove the toner remaining on the image bearer; and if necessary, further includes other units that are appropriately selected. The charging unit and the exposing unit may be collectively referred to as an electrostatic latent image forming unit.

The lubricant applying unit includes the lubricant levelling blade of the present disclosure.

An image forming method used in the present disclosure includes a lubricant applying step, a charging step, an exposing step, a developing step, a transfer step, a fixing step, and a cleaning step; and if necessary, further includes other steps that are appropriately selected.

The charging step and the exposing step may be collectively referred to as an electrostatic latent image forming step.

The image forming method used in the present disclosure can be performed more suitably by the image forming apparatus of the present disclosure, the charging step can be performed by the charging unit, the exposing step can be performed by the exposing unit, the developing step can be performed by the developing unit, the transfer step can be performed by the transfer unit, the fixing step can be performed by the fixing unit, the cleaning step can be performed by the cleaning unit, and the other steps can be performed by the other units. The lubricant applying step can be performed by the lubricant applying unit, and the lubricant applying unit includes the lubricant levelling blade of the present disclosure.

As described above, the material, shape, structure, size, etc. of the image bearer (hereinafter may be referred to as an “electrophotographic photoconductor” or a “photoconductor”) are not particularly limited and may be those appropriately selected from known ones. Examples of the shape of the image bearer include a drum and a belt. Examples of the material of the image bearer include amorphous silicon and serene for inorganic photoconductors and polysilanes and phthalopolymethine for organic photoconductors (OPCs), in addition to the aforementioned metals, plastics, and ceramics.

The lubricant applying step is a step of applying a lubricant to the surface of the image bearer and is performed by the lubricant applying unit.

The lubricant can be applied in the following manner. Specifically, the lubricant is molded into a solid. The solid of the lubricant is pressed against a fur brush using a pressing spring. The fur brush is rotated to apply the lubricant to the image bearer surface. The lubricant is allowed to be even by the lubricant levelling blade.

### <Charging Step and Charging Unit>

The charging step is a step of charging the surface of the image bearer and is performed by the charging unit.

The surface of the image bearer can be charged using, for example, the charging unit to apply voltage to the surface of the image bearer.

The charging unit is not particularly limited and may be appropriately selected depending on the intended purpose. Examples of the charging unit include contact chargers known per se provided with, for example, a conductive or semiconductive roller, brush, film, or rubber blade, and contactless chargers using corona discharge, such as corotron and scorotron.

The charging unit may be in any form, such as a roller, a magnetic brush, or a fur brush. The form of the charging unit can be selected in conformity to the specifications and form of an electrophotographic image forming apparatus. When a magnetic brush is used, the magnetic brush uses, for example, various ferrite particles such as Zn—Cu ferrite as charging means. The magnetic brush includes a non-magnetic conductive sleeve for carrying such particles and a magnet roll enclosed therein. When a brush, for example, a fur brush is used, the fur brush uses a fur that is treated to be conductive with carbon, copper sulfide, or a metal or a metal oxide. This fur is wound around or attached to a metal cored bar or other cored bars that are treated to be conductive. The resultant is used as a charger.

The charger is not limited to the contact charger as described above. The contact charger is advantageously used because an image forming apparatus including the contact charger can reduce the amount of ozone generated from the charger.

The charger is preferably a charger that is disposed in contact with or without contact with the electrostatic latent image bearer and is configured to apply superimposed DC and AC voltage to charge the image bearer surface.

Moreover, the charger is preferably a charging roller that is disposed close to the image bearer via a gap tape without contact with the image bearer, and is configured to apply superimposed DC and AC voltage to the charging roller to charge the image bearer surface.

### <Exposing Step and Exposing Unit>

The exposing step is a step of exposing the surface of the image bearer and is performed by the exposing unit.

For example, the surface of the image bearer can be exposed by exposing the surface of the image bearer to light imagewise using the exposing unit.

The optical system for exposure is roughly classified into an analog optical system and a digital optical system. The analog optical system is an optical system configured to project a text directly on the image bearer through an optical system. The digital optical system is an optical system configured to be supplied with image information in the form of an electric signal, and to convert the electric signal into an optical signal and expose the electrophotographic photoconductor to the optical signal to form an image.

The exposing unit is not particularly limited and may be appropriately selected depending on the intended purpose, as long as the exposing unit can expose the surface of the image bearer charged by the charging unit to light imagewise as the image to be formed. Examples of the exposing unit include various exposing devices of, for example, a copier optical system, a rod lens array system, a laser optical system, a liquid crystal shutter optical system, and a LED optical system.

In the present disclosure, it is also possible to employ a backlighting system configured to apply light to the image bearer from the back of the image bearer for imagewise exposure.

<Developing Step and Developing Unit>

The developing step is a step of developing the electrostatic latent image with a toner to form a visible image.

The visible image can be formed by, for example, developing the electrostatic latent image with the toner, and can be performed by the developing unit.

The developing unit is not particularly limited and may be appropriately selected from known developing units, as long as the developing unit can perform development using the toner. A preferable developing unit includes at least a developing device in which the toner is contained and that can supply the toner to the electrostatic latent image by contacting the electrostatic latent image or contactlessly.

The developing device may be of a dry developing type or a wet developing type, or may be a single-color developing device or a multi-color developing device. A preferable developing device includes: a stirrer configured to stir the toner to triboelectrically charge the toner; and a rotatable magnet roller.

In the developing device, for example, the toner and an optional carrier are mixed and stirred, and the toner gets charged due to the friction of the mixing and stirring and supported on the surface of the rotating magnet roller in a chain-like form, to form a magnetic brush. The magnet roller is disposed near the image bearer. Therefore, part of the toner constituting the magnetic brush formed on the surface of the magnet roller is transferred to the surface of the image bearer by an electric attractive force. As a result, the electrostatic latent image is developed by the toner, to form a visible image of the toner on the surface of the image bearer.

The toner contained in the developing device may be a developer containing the toner. The developer may be a one-component developer or a two-component developer.

<Transfer Step and Transfer Unit>

The transfer step is a step of transferring the visible image onto a recording medium. A preferable mode uses an intermediate transfer medium to primarily transfer the visible image onto the intermediate transfer medium and then secondarily transfer the visible image onto the recording medium. A more preferable mode uses 2 or more colors of toners and preferably toners for full color as the toner, includes a primary transfer step of transferring visible images onto an intermediate transfer medium to form a combined transferred image and a secondary transfer step of transferring the combined transferred image onto a recording medium.

For example, the visible image can be transferred onto a recording medium by charging the visible image on the image bearer with the transfer unit. A preferable mode of the transfer unit includes a primary transfer unit configured to transfer visible images onto an intermediate transfer medium to form a combined transferred image, and a secondary transfer unit configured to transfer the combined transferred image onto a recording medium.

The intermediate transfer medium is not particularly limited and may be appropriately selected depending on the intended purpose from known transfer media. Examples of the intermediate transfer medium include a transfer belt. It is preferable that the transfer unit (the primary transfer unit or the secondary transfer unit) include at least a transfer device configured to charge the visible image formed on the image bearer to be peeled to the recording medium. It is possible to provide 1 transfer unit, or 2 or more transfer units. Examples of the transfer device include a corona transfer device utilizing corona discharge, a transfer belt, a transfer roller, a pressure transfer roller, and an adhesive transfer device.

The recording medium is not particularly limited and may be appropriately selected depending on the intended purpose, as long as a developed, unfixed image can be transferred onto the recording medium. A representative example of the recording medium is plain paper. For example, a PET base for OHP can also be used.

<Fixing Step and Fixing Unit>

The fixing step is a step of fixing a toner image transferred onto the recording medium and can be performed by the fixing unit. When toners of two or more colors are used, the fixing step may be performed every time the toner of each color is transferred to the recording medium, or may be performed once in the state where the toners of all colors are transferred to and superimposed on the recording medium. The fixing unit is not particularly limited and may employ a heat-pressure system using any of heat-pressure units known in the art. Examples of the heat-pressure unit include a combination of a heat roller and a pressure roller, and a combination of a heat roller, a pressure roller, and an endless belt. The heating temperature is not particularly limited and may be appropriately selected depending on the intended purpose. The heating temperature is preferably from 80 degrees Celsius through 200 degrees Celsius. In the present disclosure, if necessary, a photo fixing device known in the art can be used together with the fixing unit.

<Cleaning Step and Cleaning Unit>

The cleaning step is a step of removing the toner remaining on the image bearer and can be suitably performed by the cleaning unit.

The cleaning unit that is used is the cleaning blade of the present disclosure.

The elastic member of the cleaning blade is not particularly limited and may be appropriately selected depending on the intended purpose. The elastic member thereof preferably contacts the image bearer surface at a pressing force of 10 N/m or higher but 100 N/m or lower. When the pressing force is 10 N/m or higher, cleaning failures does not easily occur, which would otherwise occur due to the toner passing through the contact site where the elastic member of the cleaning blade contacts the image bearer surface. When the pressing force is 100 N/m or lower, the frictions force at the contact site can be prevented from increasing, and the cleaning blade is not rolled up.

The pressing force is preferably from 10 N/m through 50 N/m.

The pressing force can be measured using, for example, a measurement device incorporating a small-sized compression load cell obtained from Kyowa Electronic Instruments Co., Ltd.

An angle (cleaning angle) θ formed between the tangent at the contact site of the elastic member of the cleaning blade with the image bearer surface and the end surface of the cleaning blade is not particularly limited and may be appropriately selected depending on the intended purpose. The angle θ is preferably 65 degrees or more but 85 degrees or lower.

When the angle θ is 65 degrees or more, the cleaning blade is not rolled up. When the angle θ is 85 degrees or less, cleaning failures do not occur.

<Other Steps and Other Units>

Examples of the other units include a charge-eliminating unit, a recycling unit, and a controlling unit.

Examples of the other steps include a charge-eliminating step, a recycling step, and a controlling step.

—Charge-Eliminating Step and Charge-Eliminating Unit—

The charge-eliminating step is a step of applying a charge-eliminating bias to the image bearer to eliminate charges and can be suitably performed by the charge-eliminating unit.

The charge-eliminating unit is not particularly limited and may be appropriately selected from known charge-eliminating devices, as long as the charge-eliminating unit can apply a charge-eliminating bias to the image bearer. Preferable examples of the charge-eliminating unit include a charge-eliminating lamp.

—Recycling Step and Recycling Unit—

The recycling step is a step of recycling the toner removed in the cleaning step to the developing unit and can be suitably performed by the recycling unit.

The recycling unit is not particularly limited. Examples of the recycling unit include known conveying units.

—Controlling Step and Controlling Unit—

The controlling step is a step of controlling each of the steps described above and can be suitably performed by the controlling unit.

The controlling unit is not particularly limited and may be appropriately selected depending on the intended purpose, as long as the controlling unit can control the operation of each unit. Examples of the controlling unit include devices such as a sequencer and a computer.

Now, one example of the image forming apparatus of the present disclosure will be described with reference to the drawings.

FIG. 3 is a schematic structural view illustrating one example of an image forming apparatus 500 of the present disclosure. The image forming apparatus 500 is equipped with four image formation units for yellow, magenta, cyan, and black (hereinafter may be referred to as Y, C, M, and K, respectively) and these four image formation units are denoted by 1Y, 1C, 1M, 1K. The image formation units 1Y, 1C, 1M, 1K have the same structure, provided that the image formation units use toners of different colors; i.e., Y, C, M, and K toners.

A transfer unit 60 equipped with an intermediate transfer belt 14 serving as an intermediate transfer member is provided at the upper side of the four image formation units. Toner images of the aforementioned colors formed on surfaces of photoconductors 3Y, 3C, 3M, 3K contained in the image formation units 1Y, 1C, 1M, 1K, details of which is described below, are transferred and superimposed on a surface of the intermediate transfer belt 14.

Moreover, a light writing unit 40 is provided at the bottom side of the image formation units 1. The light writing unit 40, serving as a latent image forming unit, is configured to irradiate the photoconductors 3Y, 3C, 3M, 3K in the image formation units 1Y, 1C, 1M, 1K with laser light L based on image information. As a result of the irradiation, electrostatic latent images for Y, C, M, and K are formed on the photoconductors 3Y, 3C, 3M, 3K. The light writing unit 40 is configured to apply the laser light L emitted from a light source to the photoconductors 3Y, 3C, 3M, 3K through a plurality of optical lenses or mirrors, while polarizing the light with a polygon mirror 41 that is rotationally driven by a motor. Instead of such a configuration, it may be possible to employ another configuration in which light scanning is performed with an LED array.

At the bottom of the light writing unit 40, a first paper feeding cassette 151 and a second paper feeding cassette 152 are provided in a manner that they are overlapped in the vertical direction. In each of these paper feeding cassettes, recording media P are housed in the state of a paper bundle where a plurality of paper sheets are stacked. The recording medium P placed on the top in each cassette is in contact with a first paper feeding roller 151a and a second paper feeding roller 152a, respectively. Once the first paper feeding roller 151a is rotationally driven in the anticlockwise direction of the drawing by a driving unit, the recording medium P placed on the top in the first paper feeding cassette 151 is discharged to a paper feeding path 153 provided in the vertical direction at the right side of the cassette in FIG. 3. Once the second paper feeding roller 152a is rotationally driven in the anticlockwise direction in FIG. 3 by a driving unit, the recording medium P placed on the top in the second paper feeding cassette 152 is discharged to the paper feeding path 153.

A plurality of pairs of convey rollers 154 are provided in the paper feeding path 153. The recording medium P sent to the paper feeding path 153 is conveyed from the bottom to the top within the paper feeding path 153 in FIG. 3 with being nipped with the pairs of the convey rollers 154.

A pair of registration rollers 55 is provided at the downstream end part of the paper feeding path 153 relative to the traveling direction of the recording medium P. Once the pair of the registration rollers 55 nips therebetween the recording medium P transported from the pair of the convey rollers 154, the rotation of the pair of the convey rollers 154 is stopped temporarily. Then, the recording medium P is sent to the below-mentioned secondary transfer nip at an appropriate timing.

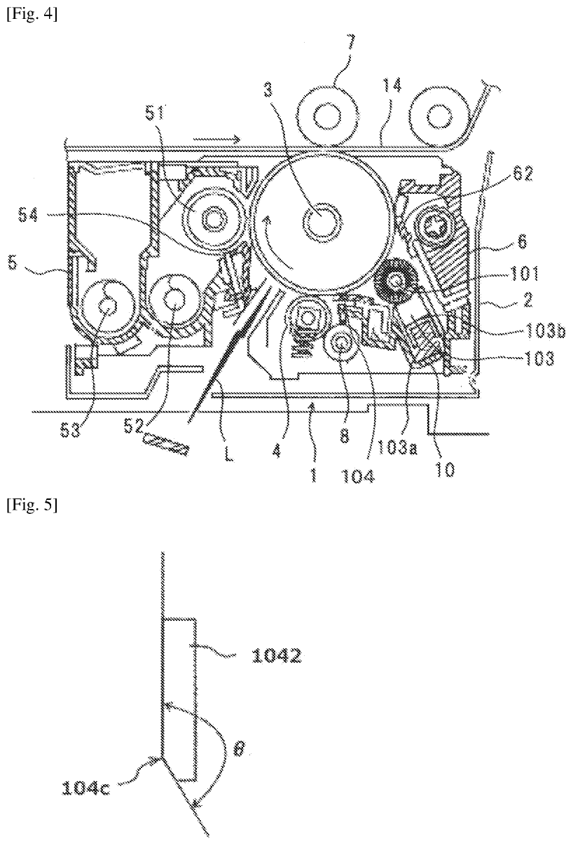

FIG. 4 is a schematic view illustrating the structure of one of the four image formation units 1.

As illustrated in FIG. 4, the image formation unit 1 is equipped with a drum-shaped photoconductor 3 serving as the image bearer. Although the photoconductor 3 has a drum shape, the photoconductor 3 may be a sheet-type photoconductor or an endless belt-type photoconductor.

In the surrounding area of the photoconductor 3, a charging roller 4, a developing device 5, a primary transfer roller 7, a cleaning device 6, a lubricant applicator 10, a charge-eliminating lamp, etc. are provided. The charging roller 4 is a charging member equipped in a charging device serving as a charging unit. The developing device 5 is a developing unit configured to develop a latent image formed on a surface of the photoconductor 3 with a toner to form a toner image. The primary transfer roller 7 is a primary transfer member equipped in a primary transfer device serving as a primary transfer unit, which is configured to transfer the toner image formed on the surface of the photoconductor 3 to an intermediate transfer belt 14. The cleaning device 6 is a cleaning unit configured to remove the toner remaining on the surface of the photoconductor 3, from which the toner image has been transferred to the intermediate transfer belt 14. The lubricant applicator 10 is a lubricant applying unit configured to apply a lubricant onto the surface of the photoconductor 3 after the cleaning by the cleaning device 6. The lubricant applicator 10 includes a solid lubricant 103, a lubricant pressing spring 103a, a bracket 103b, and the lubricant levelling blade 104 of the present disclosure. The charge-eliminating lamp is a change-eliminating unit configured to eliminate the surface potential of the photoconductor 3 after the cleaning.

The charging roller 4 is provided in a contactless manner, with a certain space to the photoconductor 3, and is configured to charge the photoconductor 3 with the predetermined polarity and predetermined potential. The laser light L is emitted from the light writing unit 40 to a surface of the photoconductor 3, which has been uniformly charged by the charging roller 4, based on image information, to thereby form an electrostatic latent image.

The developing device 5 includes a developing roller 51 serving as a developer bearer. To the developing roller 51, developing bias is applied from a power source. In a casing of the developing device 5, provided are a supply screw 52 and a stirring screw 53, which are configured to stir a developer housed in the casing, white transporting in the mutually different directions. Moreover, also provided is a doctor 54 configured to regulate the developer held on the developing roller 51. The toner in the developer stirred and transported by two screws of the supply screw 52 and the stirring screw 53 is charged to the predetermined polarity. The developer is then scooped on a surface of the developing roller 51, the scooped developer is regulated by the doctor 54, and the toner is deposited on a latent image on the photoconductor 3 in a developing region facing the photoconductor 3.

The cleaning device 6 includes, for example, a fur brush 101 and a cleaning blade 62. The cleaning blade 62 is brought into contact with the photoconductor 3 in a counter direction to the surface-moving direction of the photoconductor 3. The charging device is that of a contactless adjacent setting type, where the charging roller 4 is provided adjacent to the photoconductor 3. However, the charging device may be a known one such as corotron, scorotron, or a solid state charger. Among these charging types, especially, a contact type or a contactless adjacent setting type is desired. These types have advantages such as high charging efficiency with a small amount of ozone generated, and being possible to downsize the device.

A light source of laser light L of the light writing unit 40, and a light source of the charge-eliminating lamp may be all kinds of light emitters such as a fluorescent lamp, a tungsten lamp, a halogen lamp, a mercury lamp, a sodium lamp, a light-emitting diode (LED), a laser diode (LD), and an electroluminescent (EL) lamp.

In order to apply only light having the desired wavelength range, it may be possible to use various kinds of filters such as a sharp-cut filter, a band-pass filter, a near infrared-cut filter, a dichroic filter, an interference filter, and a color temperature conversion filter.

Of these light sources, preferred are a light-emitting diode and a laser diode, because they can apply light having a long wavelength of 600 nm to 800 nm.

The transfer unit 60 as illustrated in FIG. 3, serving as the above transfer unit, is equipped with, for example, an intermediate transfer belt 14, a belt-cleaning unit 162, a first bracket 63, and a second bracket 64. Moreover, the transfer unit 60 is further equipped with, for example, four primary transfer rollers 7Y, 7C, 7M, 7K, a secondary transfer back-up roller 66, a driving roller 67, a support roller 68, and a tension roller 69. The intermediate transfer belt 14 is endlessly rotated in the anticlockwise direction in FIG. 3 by the rotational driving of the driving roller 67, while supported by these eight roller members. The four primary transfer rollers 7Y, 7C, 7M, 7K nip the intermediate transfer belt 14 with the photoconductors 3Y, 3C, 3M, 3K, respectively, to thereby form primary transfer nips. Then, a transfer bias having an opposite polarity (e.g., plus) to that of the toner is applied to the back surface of the intermediate transfer belt 14 (the internal perimeter surface of the loop). In the process that the intermediate transfer belt 14 successively passes through the primary transfer nips for Y, C, M, and K in accordance with the endless movement, Y, C, M, and K toner images formed on the photoconductors 3Y, 3C, 3M, 3K are superimposed on the surface of the intermediate transfer belt 14 (the outer perimeter surface of the loop) to thereby perform primary transfer. As a result, a four-color-superimposed toner image (hereinafter may be referred to as a four-color toner image) is formed on the intermediate transfer belt 14.

The secondary transfer back-up roller 66 nips the intermediate transfer belt 14 with the secondary transfer roller 70 provided at the outer side of the loop of the intermediate transfer belt 14, to thereby form a secondary transfer nip. The aforementioned pair of registration rollers 55 sends the recording medium P, which has been nipped between the rollers, to the secondary transfer nip at timing to synchronize to the four-color toner image formed on the intermediate transfer belt 14. The four-color toner image formed on the intermediate transfer belt 14 is secondary transferred to the recording medium P in the secondary transfer nip by influences of a secondary transfer electric field formed between the secondary transfer roller 70 and the secondary transfer back-up roller 66, to which secondary transfer bias is applied, or nip pressure. As a result, a full-color toner image is formed with the white color of the recording medium P.

The toner, which has not been transferred to the recording medium P, is deposited on the intermediate transfer belt 14, which has passed through the secondary transfer nip. Therefore, the intermediate transfer belt 14 is cleaned by a belt-cleaning unit 162. Note that, the belt-cleaning unit 162 contains a belt cleaning blade 162a that is brought into contact with the surface of the intermediate transfer belt 14 (the outer perimeter surface of the loop) to scrape and remove the toner remaining on the intermediate transfer belt 14.

The first bracket 63 in the transfer unit 60 is rocked at the predetermined rotational angle by on-off driving of a solenoid with the rotational axis of the support roller 68 being a center. In the case where the image forming apparatus 500 forms a monochromic image, the first bracket 63 is rotated only a little in the anticlockwise direction in FIG. 3 by the driving of the solenoid. Specifically, the intermediate transfer belt 14 is separated from the photoconductors 3Y, 3C, 3M for Y, C, and M by rotating the primary transfer rollers 7Y, 7C, 7M in the anticlockwise direction in FIG. 3 with the rotational axis of the support roller 68 being a center. Then, a monochromic image is formed by driving only the image formation unit 1K for K among the four image formation units 1Y, 1C, 1M, 1K. As a result, it is possible to avoid consumptions of the constituting members of the image formation units 1 for Y, C, and M, which will be caused by unnecessarily driving them when a monochromic image is formed.

The fixing unit 80 is provided at the upper side of the secondary transfer nip in FIG. 3. The fixing unit 80 is equipped with a press heat roller 81, which includes therein a heat source such as a halogen lamp, and a fixing belt unit 82. The fixing belt unit 82 includes a fixing belt 84, a heat roller 83, which includes therein a heat source such as a halogen lamp, a tension roller 85, a driving roller 86, and a temperature sensor. The fixing belt 84 that is endless travels in the anticlockwise direction in FIG. 3, with supported by the heat roller 83, the tension roller 85, and the driving roller 86. In the process of the endless movement, the fixing belt 84 is heated from the side of the back surface by the heat roller 83. The press heat roller 81, which is rotationally driven in the clockwise direction in FIG. 3, is brought into contact with the front surface of the fixing belt 84 at the position where the fixing belt 84, which is heated in the above-described manner, is supported by the heat roller 83. As a result, a fixing nip, at which the press heat roller 81 and the fixing belt 84 are brought into contact with each other, is formed.

The temperature sensor is provided at the outer side of the loop of the fixing belt 84 in the manner that, the temperature sensor faces the front surface of the fixing belt 84 with the predetermined space, and the temperature sensor detects the surface temperature of the fixing belt 84 just before entering the fixing nip. The detected result is sent to the fixing power source circuit. The fixing power source circuit controls, with on-off, a heat source included in the heat roller 83, or a heat source included in the press heat roller 81, based on the detected result of the temperature sensor.

The recording medium P passed through the aforementioned secondary transfer nip is separated from the intermediate transfer belt 14, followed by sending into the fixing unit 80. The recording medium P is then nipped at the fixing nip in the fixing unit 80 to be transported from the bottom side to the upper side in FIG. 4. In this process, the recording medium P is heated and pressed by the fixing belt 84, to thereby fix the full-color toner image on the recording medium P.

The recording medium P, on which the toner image has been fixed in this manner, is passed through a pair of paper ejection rollers 87, and is then discharged outside the apparatus. A stacking unit 88 is formed on the top surface of the housing of the main body of the image forming apparatus 500. The recording medium P discharged outside the apparatus by the pair of the paper ejection rollers 87 is sequentially stacked in the stacking unit 88.

Toner cartridges 100Y, 100C, 100M, 100K, configured to house the Y, C, M, and K toners therein, are provided above the transfer unit 60. The Y, C, M, and K toners in the toner cartridges 100Y, 100C, 100M, 100K are appropriately supplied to the developing devices 5Y, 5C, 5M, 5K in the image formation units 1Y, 1C, 1M, 1K. The toner cartridges 100Y, 100C, 100M, 100K are mounted independently of the image formation units 1Y, 1C, 1M, 1K, and can be detachably mounted in the main body of the image forming apparatus.

Next, image forming operations performed in the image forming apparatus 500 will be described.

Once a signal for a print execution from an operation unit is received, the predetermined voltage or electric current is applied to the charging roller 4 and the developing roller 51 successively at the predetermined timings. Similarly, the predetermined voltage or electric current is applied to a light source of the light writing unit 40 and a light source such as the charge-eliminating lamp successively at the predetermined timings. In the synchronized motions to this, the photoconductor 3 is rotationally driven in the direction shown with the arrow in FIG. 3 by a photoconductor driving motor serving as a driving unit.

Once the photoconductor 3 is rotated in the direction shown with the arrow in FIG. 3, first, a surface of the photoconductor 3 is uniformly charged to the predetermined potential by the charging roller 4. Then, laser light L is applied to the surface of the photoconductor 3 from the light writing unit 40 corresponding to the image information. As a result, the charges in an area of the surface of the photoconductor 3, where the laser light L is applied, are eliminated, to thereby form an electrostatic latent image.

The surface of the photoconductor 3, on which the electrostatic latent image has been formed, is rubbed by a magnetic brush, which is composed of a developer and formed on the developing roller 51, in the region facing the developing device 5. In this operation, the negatively charged toner on the developing roller 51 is transported to the side of the electrostatic latent image by the predetermined developing bias applied to the developing roller 51, to thereby form a toner image (development). The similar image formation process is performed in the image formation units 1Y, 1C, 1M, 1K, and the toner images of respective colors are formed on the surfaces of the photo conductors 3Y, 3C, 3M, 3K.

As mentioned above, the electrostatic latent image formed on the photoconductor 3 is reversely developed with the negatively charged toner by the developing device 5 in the image forming apparatus 500. In the embodiment, an N/P (negative-positive: a toner is deposited on an area having the lower potential) contactless charging roller system is described above, but a system for use is not limited to the aforementioned system. The toner images of respective colors formed on the surfaces of the photoconductors 3Y, 3C, 3M, 3K are sequentially primary transferred so that they are superimposed on a surface of the intermediate transfer belt 14. As a result, the four-color toner image is formed on the intermediate transfer belt 14.

The four-color toner image formed on the intermediate transfer belt 14 is transferred to recording medium P, which is fed from the first paper feeding cassette 151 or the second paper feeding cassette 152, and is fed to the secondary transfer nip with going through between the pair of the registration rollers 55. During this operation, the recording medium P is temporarily stopped with being nipped between the pair of the registration rollers 55, is synchronized with the edge of the image on the intermediate transfer belt 14, and is supplied to the secondary transfer nip. The recording medium P, to which the toner image has been transferred, is separated from the intermediate transfer belt 14, and is sent to the fixing unit 80. As the recording medium P, to which the toner image has been transferred, passes through the fixing unit 80, the toner image is fixed on the recording medium P by heat and pressure. The recording medium P, to which the toner image has been fixed, is discharged outside the image forming apparatus 500, and is stacked in the stacking unit 88.

Meanwhile, the toner remaining on the surface of the intermediate transfer belt 14, from which the toner image has been transferred to the recording medium P at the secondary transfer nip, is removed by the belt-cleaning unit 162.

Moreover, the toner remaining on the surface of the photoconductor 3, from which the toner image has been transferred to the intermediate transfer belt 14 at the primary transfer nip, is removed by the cleaning device 6. Thereafter, a lubricant is applied to the surface of the photoconductor 3 by the lubricant applicator 10, followed by charge-eliminating the surface thereof by the charge-eliminating lamp.

As illustrated in FIG. 4, the image formation unit 1 in the image forming apparatus 500 is composed of the photoconductor 3, and as process units, the charging roller 4, the developing device 5, the cleaning device 6, and the lubricant applicator 10, all of which are housed in a frame body 2. The image formation unit 1 is detachably mounted, as a process cartridge, in the main body of the image forming apparatus 500. In the image forming apparatus 500, the image formation unit 1 has a configuration that the photoconductor 3 and the process units are integrally replaced as a process cartridge. However, a configuration for use may be a configuration where the photoconductor 3, the charging roller 4, the developing device 5, the cleaning device 6, and the lubricant applicator 10 are individually replaced per unit.

As a toner used for the image forming apparatus 500, a polymerization toner produced by a suspension polymerization method, an emulsion polymerization method, or a dispersion polymerization method, with all of which high circularity of particles and a small particle size are easily achieved, is preferably used in order to improve image quality. Particularly, a polymerization toner having a volume average particle diameter of 5.5 μm or less is preferably used. Since the polymerization toner having the volume average particle diameter of 5.5 μm or less is used, images of higher resolution can be formed.

The lubricant levelling blade can be produced by, for example, a production method including the following molding step.

Sheet Molding Method
(1) A liquid reaction composition is cast-molded into a sheet, followed by curing reaction, to form a rolled sheet. The rolled sheet is cut into a blade (a cutting step). In general, centrifugal molding is used for sheet molding.

(2) The blade is mounted via, for example, an adhesive to a supporting member (e.g., a metal fixture) for mounting the blade to an image forming apparatus, to form a blade unit.

Direct Molding Method

A supporting member (e.g., a metal fixture) for mounting a blade to an image forming apparatus is, if necessary, disposed in a mold with a cavity having a shape of a blade to be molded. A liquid reaction composition is cast-molded in the mold cavity to form a blade or a blade unit.

### EXAMPLES

The present disclosure will be described in more detail by way of Examples and Comparative Examples. However, the present disclosure should not be construed as being limited to these Examples. In the following, the units “part(s)” and “%” means “part(s) by mass” and “% by mass”, respectively, unless otherwise specified.

### Example 1

(Formation of Base)

As the base of an elastic member, a sheet of a polyurethane elastomer having the following film thickness, JIS-A hardness, modulus of repulsion elasticity at 23 degrees Celsius, and Martens hardness (HM) was formed through centrifugal molding.

Film thickness: 0.8 mm

JIS-A hardness: 60 degrees

Modulus of repulsion elasticity at 23 degrees Celsius: 35%

Martens hardness (HM): 0.6 N/mm²

Measurement methods of the JIS-A hardness, the modulus of repulsion elasticity, and the Martens hardness (HM) are described below.

(JIS-A Hardness of the Base)

The JIS-A hardness of the base was measured by using micro durometer MD-1 obtained from KOBUNSHI KEIKI CO., LTD. in compliant with JIS K6253 (23 degrees Celsius).

(Modulus of Repulsion Elasticity of the Base)

The modulus of repulsion elasticity of the base of the elastic member was measured at 23 degrees Celsius using No. 221 Resilience Tester obtained from Toyo Seiki Seisaku-sho, Ltd. in compliant with JIS K6255. A sample used was a laminate obtained by superimposing sheets each having a thickness of 1.5 mm so as to have a total thickness of 4 mm or larger.

(Martens Hardness of the Base)

The measurement method for the Martens hardness (HM) is as follows.

The Martens hardness (HM) was measured in compliant with ISO14577 using nanoindenter ENT-3100 obtained from ELIONIX INC. by indenting a Berkovich indenter at a load of 1000 μN for 10 seconds, retaining for 5 seconds, and pulling it off at the same rate of loading for 10 seconds.

The measurement position for the Martens hardness was a position 20 μm apart from the leading end ridge portion at a side of the contact surface, with a member to be cleaned, of a base that had been obtained by forming a molded sheet into a blade.

As a result of the measurement by the above-described measurement method, the Martens hardness (HM) of the base was found to be 0.6 N/mm².

(Formation of Surface Layer)

7.5 parts of diethylmethylbenzenediamine (DETDA) obtained from MITSUI FINE CHEMICALS, INC Co., Ltd. was added to 100 parts of a prepolymer (NCO %=3.8%), which had been obtained by substituting both ends of polytetramethylene ether glycol obtained from Mitsui Chemicals, Inc. (PTMG, number average molecular weight Mn: 1000) with dicyclohexylmethane 4,4′-diisocyanate (hydrogenated MDI) obtained from TOKYO CHEMICAL INDUSTRY CO., LTD. The resultant mixture was stirred to prepare a surface layer forming liquid. The surface layer forming liquid was charged to the surface of the base in a centrifugal molding apparatus containing the centrifugally molded base, where the centrifugal molding apparatus was retained at a temperature of 120 degrees Celsius. The molding time was set to 0.5 hours, and two polyurethane elastomer sheets having a total thickness of 0.4 mm (the total thickness of the final sheet: 1.2 mm) was formed. After post-curing and conditioning, the resultant was subjected to a process into a lubricant applying blade (the process including cutting to an obtuse angle) to form a lubricant levelling blade of Example 1 including the two surface layers.

### Examples 2 to 11 and Comparative Examples 1 and 2

In the same manner as in Example 1 except for the conditions described in Tables 1-1 and 1-2, lubricant levelling blades of Examples 2 to 11 and Comparative Examples 1 and 2 were formed.

The prepolymer described in Examples 2 to 8 were synthesized by substituting both ends of polytetramethylene ether glycol obtained from Mitsui Chemicals, Inc. (PTMG) with dicyclohexylmethane 4,4′-diisocyanate (hydrogenated MDI) obtained from TOKYO CHEMICAL INDUSTRY CO., LTD. so as to have the NCO % presented in Table 1-1.

In Examples 10 and 11, the following materials were used to allow isocyanate and polyol to react with each other, to synthesize a prepolymer having an NCO % of 6.3%.

Isocyanate: tolylene diisocyanate (TDI)

(obtained from Mitsui Chemicals, Inc., “COSMONATE T100”)

Polyol: polybutylene adipate (PBA, molecular weight: 2000)

(obtained from Nippon Polyurethane Industry Co., Ltd., “NIPPOLAN 4010”)

Chain extender: 1,4-butanediol (1,4BD) (obtained from Mitsui Chemicals, Inc.)

Cross-linking agent: trimethylolpropane (TMP) (obtained from MITSUBISHI GAS CHEMICAL COMPANY, INC.)

### Example 9

A lubricant levelling blade was formed in the same manner as in Example 8 except that the base was not used, the surface layer was molded under the conditions described in Tables 1-1 and 1-2, and the film thickness of the polyurethane elastomer was adjusted to 1.0 mm (monolayered).

TABLE 1-1

| | | Base | | | | | | | |
|---|---|---|---|---|---|---|---|---|---|
| | | | Film | Surface layer | | | | | |
| | | W or | thickness | W or | Kind of | Polyol | | Prepolymer | |
| | | W/O | [mm] | W/O | isocyanate | Kind | M.W. | NCO % | Parts |
| Ex. | 1 | W | 0.8 | W | Hydrogenated | PTMG | 1000 | 3.8 | 100 |
| | | | | | MDI | | | | |
| | 2 | W | 0.8 | W | Hydrogenated | PTMG | 1400 | 3.8 | 100 |
| | | | | | MDI | | | | |
| | 3 | W | 0.8 | W | Hydrogenated | PTMG | 850 | 4.5 | 100 |
| | | | | | MDI | | | | |
| | 4 | W | 0.8 | W | Hydrogenated | PTMG | 1000 | 11.6 | 100 |
| | | | | | MDI | | | | |
| | 5 | W | 0.8 | W | Hydrogenated | PTMG | 1000 | 11.6 | 100 |
| | | | | | MDI | | | | |
| | 6 | W | 0.8 | W | Hydrogenated | PTMG | 1000 | 11.6 | 100 |
| | | | | | MDI | | | | |
| | 7 | W | 0.8 | W | Hydrogenated | PTMG | 1000 | 11.6 | 100 |
| | | | | | MDI | | | | |
| | 8 | W | 0.8 | W | Hydrogenated | PTMG | 850 | 11.6 | 100 |
| | | | | | MDI | | | | |
| | 9 | W/O | — | W | Hydrogenated | PTMG | 850 | 4.5 | 100 |
| | | | | | MDI | | | | |
| | 10 | W | 0.8 | W | TDI | PBA | 2000 | 6.3 | 100 |
| | 11 | W | 0.8 | W | TDI | PBA | 2000 | 6.3 | 100 |
| Comp. | 1 | W | 0.8 | W | Hydrogenated | PTMG | 1000 | 3.8 | 100 |
| Ex. | | | | | MDI | | | | |
| | 2 | W | 0.8 | W | Hydrogenated | PTMG | 850 | 11.6 | 100 |
| | | | | | MDI | | | | |

In Table 1-1, “W” stands for “With” meaning being present, and “W/O” stands for “Without” meaning being absent. Also, “M.W.” stands for “Molecular Weight”.

TABLE 1-2

| | | Surface layer | | | | | | |
|---|---|---|---|---|---|---|---|---|
| | | | | | | Mold- | Mold- | Film |
| | | | | | | ing | ing | thick- |
| | | Curing agent | | | | temp. | time | ness |
| | | Kind | Parts | Kind | Parts | [° C.] | [h] | [mm] |
| Ex. | 1 | DETDA | 7.5 | — | — | 120 | 0.5 | 0.4 |
| | 2 | DETDA | 7.5 | — | — | 100 | 2 | 0.4 |
| | 3 | DETDA | 8.8 | — | — | 110 | 0.5 | 0.4 |
| | 4 | DETDA | 5.0 | — | — | 100 | 1 | 0.4 |
| | 5 | DETDA | 5.0 | — | — | 100 | 1 | 0.4 |
| | 6 | DETDA | 5.0 | — | — | 100 | 1 | 0.4 |
| | 7 | DETDA | 5.0 | — | — | 100 | 2 | 0.4 |
| | 8 | DETDA | 5.0 | — | — | 100 | 5 | 0.4 |
| | 9 | DETDA | 8.8 | — | — | 120 | 1 | 1 |
| | 10 | 1,4BD | 5.5 | TMP | 4.5 | 110 | 0.5 | 0.4 |
| | 11 | 1,4BD | 6.6 | TMP | 3.4 | 120 | 0.5 | 0.4 |
| Comp. | 1 | DETDA | 7.5 | — | — | 150 | 0.5 | 0.4 |
| Ex. | 2 | DETDA | 4.9 | — | — | 100 | 5 | 0.4 |

<Martens Hardness of Surface Layer>

The Martens hardness of the surface layer was measured in the same manner as in the measurement method for the Martens hardness of the base. The measurement position was a position 20 μcm apart from the leading end ridge portion of the surface layer.

<Glass Transition Temperature>

Measurement of the glass transition temperature of the polyurethane elastomer was performed using DMS6100 obtained from Hitachi High-Tech Corporation at a frequency of 10 Hz. The tans peak temperature was read and defined as the glass transition temperature.

<Assembling of Image Forming Apparatus>

Each of the lubricant levelling blade formed in Examples and Comparative Examples was mounted to a process cartridge of a color multifunction peripheral (IMAGIO MP C4500, obtained from Ricoh Company, Ltd.) (the printer portion thereof having the same structure as that of the image forming apparatus 500 illustrated in FIG. 3) to assemble image forming apparatuses of Examples and Comparative Examples.

The lubricant levelling blade was mounted to the image forming apparatus at a liner pressure of 10 g/cm and a cleaning angle of 79 degrees.

<Evaluation of Crack Formation>

Each of the image forming apparatuses was used to continuously make output in a low-temperature, low-humidity environment; i.e., 10 degrees Celsius/15% RH under the following paper sheet-feeding conditions; i.e., 500 paper sheets (A4 size, transverse) each having a band chart with an image area of 10% (the band being in the paper sheet-feeding direction). This output was repeated 10 times for the image forming apparatus to feed 5,000 paper sheets therethrough. After that, the edge portion of the lubricant levelling blade was observed with a laser microscope (LEXT OLS4500, obtained from Olympus Corporation).

—Evaluation Criteria—

A: No crack was observed the lubricant levelling blade in the longer direction thereof.

B: Cracks were partially observed in the lubricant levelling blade, but did not give adverse effects to the output image; i.e., being a non-problematic level in practical use.

C: Cracks were observed in the lubricant levelling blade, and gave adverse effects to the corresponding part on the output image; i.e., being a problematic level in practical use.

<Evaluation of Image Quality>

Each of the image forming apparatus was used to continuously make output in a laboratory environment; i.e., 23 degrees Celsius/50% RH under the following paper sheet-feeding conditions; i.e., 200,000 paper sheets (A4 size, transverse) each having a chart with an image area ratio of 0% (blank paper). After that, a halftone image was output to evaluate the extent of unevenness in the longer direction of the photoconductor. Incidentally, our finding is that the more evenly the lubricant is applied on the photoconductor in the longer direction thereof, the less the unevenness is on the image.

—Evaluation Criteria—

A: No or almost no unevenness was on the halftone image.

B: Some unevenness was on the halftone image, but at a non-problematic level in practical use.

C: Unevenness was on the whole halftone image, and at a problematic level in practical use.

Characteristic values and evaluation results in Examples and Comparative Examples are summarized in Table 2.

TABLE 2

| | | | | Angle of | | |
|---|---|---|---|---|---|---|
| | | Martens | Grass | leading | | |
| | | hardness | transition | end ridge | Evaluation | Evaluation |
| | | HM | temp. | portion | of crack | of image |
| | | [N/mm²] | [° C.] | [°] | formation | quality |
| Ex. | 1 | 1.5 | −15.8 | 90 | A | B |
| | 2 | 1.5 | −30.0 | 90 | A | B |
| | 3 | 5 | −10.0 | 125 | B | A |
| | 4 | 10 | −14.5 | 90 | A | B |
| | 5 | 10 | −14.5 | 125 | A | A |
| | 6 | 10 | −14.5 | 140 | A | B |
| | 7 | 20 | −9.5 | 125 | B | A |
| | 8 | 30 | −2.0 | 90 | B | B |
| | 9 | 3.5 | −20.0 | 90 | B | B |
| | 10 | 5.5 | −10.0 | 90 | B | B |
| | 11 | 1.5 | 0 | 90 | B | B |
| Comp. | 1 | 1.3 | 0.5 | 90 | C | C |
| Ex. | 2 | 31 | 1 | 90 | — | — |

In Comparative Example 2, the Martens hardness HM of the leading end portion was high; i.e., 31 N/mm², and the edge was difficult to form through cutting, to be unable to evenly form a leading end ridge portion; therefore, evaluation was impossible (even if the evaluation had been made, there would have been a risk of occurrence of failures such as run-through of the lubricant as a mass).

In Comparative Example 1, the Martens hardness (HM) was low; i.e., 1.3 N/mm², which was why the behaviors of the blade were unstable, to be unable to evenly apply the lubricant, resulting in the poor evaluation results of image quality. Further, since the glass transition temperature was high; i.e., 0.5 degrees Celsius, the blade was cracked in the low-temperature, low-humidity environment.

Aspects and embodiments of the present disclosure are as follows, for example.

<1> A lubricant levelling blade, including:
an elastic member configured to contact a surface of an image bearer to apply a lubricant to the surface of the image bearer,
wherein a contact surface of the elastic member with the image bearer is a polyurethane elastomer, and
a Martens hardness HM of the contact surface of the elastic member with the image bearer is 1.5 N/mm² or higher but 30.0 N/mm² or lower.

<2> The lubricant levelling blade according to <1> above, wherein the elastic member has a monolayered structure or a multilayered structure.

<3> The lubricant levelling blade according to <1> or <2> above, wherein a glass transition temperature of the polyurethane elastomer is −30 degrees Celsius or higher but 0 degrees Celsius or lower.

<4> The lubricant levelling blade according to any one of <1> to <3> above, wherein an angle of a leading end ridge portion of the elastic member is from 90 degrees through 140 degrees.

<5> A process cartridge, including:
an image bearer; and
a lubricant applying unit configured to apply a lubricant to the image bearer,
wherein the lubricant applying unit includes the lubricant levelling blade according to any one of <1> to <4> above.

<6> An image forming apparatus, including:
an image bearer;
a lubricant applying unit configured to apply a lubricant to a surface of the image bearer;
a charging unit configured to charge the surface of the image bearer;
an exposing unit configured to expose the image bearer charged to light to form an electrostatic latent image;
a developing unit configured to develop the electrostatic latent image with a toner to form a visible image;
a transfer unit configured to transfer the visible image to a recording medium; a fixing unit configured to fix the visible image transferred to the recording medium; and
a cleaning unit configured to remove the toner remaining on the image bearer,
wherein the lubricant applying unit includes the lubricant levelling blade according to any one of <1> to <4> above.

<7> An image forming method, including:
applying a lubricant to a surface of an image bearer;
charging the surface of the image bearer;
exposing image bearer charged to light to form an electrostatic latent image; developing the electrostatic latent image with a toner to form a visible image; transferring the visible image to a recording medium;
fixing the visible image transferred to the recording medium; and removing the toner remaining on the image bearer,
wherein the applying uses the lubricant levelling blade according to any one of <1> to <4> above.

The lubricant levelling blade according to any one of <1> to <4> above, the process cartridge according to <5> above, the image forming apparatus according to <6> above, and the image forming method according to <7> above can solve the existing problems in the art and achieve the object of the present disclosure.

### REFERENCE SIGNS LIST

1, 1Y, 1C, 1M, 1K image formation unit
2 frame body
3, 3Y, 3C, 3M, 3K photoconductor (image bearer)
4 charging roller
5, 5Y, 5C, 5M, 5K developing device
6 cleaning device
7, 7Y, 7C, 7M, 7K primary transfer roller
10 lubricant applicator
14 intermediate transfer belt
40 light writing unit
41 polygon mirror
51 developing roller
52 supply screw
53 stirring screw
54 doctor
55 pair of registration rollers
60 transfer unit
62 cleaning blade
63 first bracket
64 second bracket
66 secondary transfer back-up roller
67 driving roller
68 support roller
69 tension roller
70 secondary transfer roller
80 fixing unit
81 press heat roller
82 fixing belt unit
83 heat roller
84 fixing belt
85 tension roller
86 driving roller
87 pair of paper ejection rollers
88 stacking unit
100Y, 100C, 100M, 100K toner cartridge
101 fur brush
103 solid lubricant
103a lubricant pressing spring
103b bracket
104 lubricant levelling blade
151 first paper feeding cassette
151a first paper feeding roller
152 second paper feeding cassette
152b second paper feeding roller
153 paper feeding path
154 pairs of the convey rollers
162 belt-cleaning unit
162a belt-cleaning blade
500 image forming apparatus
1041 supporting member
1042 elastic member
104a blade leading end surface
104b blade bottom surface
104c contact surface (leading end ridge portion)
L laser light
P recording medium

1. A lubricant levelling blade, comprising:
an elastic member configured to contact a surface of an image bearer to apply a lubricant to the surface of the image bearer,
wherein a contact surface of the elastic member with the image bearer is a polyurethane elastomer, and
a Martens hardness HM of the contact surface of the elastic member with the image bearer is 1.5 N/mm² or higher but 30.0 N/mm² or lower.

2. The lubricant levelling blade according to claim 1, wherein the elastic member has a monolayered structure or a multilayered structure.

3. The lubricant levelling blade according to claim 1, wherein a glass transition temperature of the polyurethane elastomer is −30 degrees Celsius or higher but 0 degrees Celsius or lower.

4. The lubricant levelling blade according to claim 1, wherein an angle of a leading end ridge portion of the elastic member is from 90 degrees through 140 degrees.

5. A process cartridge, comprising:
an image bearer; and
a lubricant applier configured to apply a lubricant to the image bearer,
wherein the lubricant applier includes the lubricant levelling blade according to claim 1.

6. An image forming apparatus, comprising:
an image bearer;
a lubricant applier configured to apply a lubricant to a surface of the image bearer;
a charger configured to charge the surface of the image bearer;
an exposer configured to expose the image bearer charged to light to form an electrostatic latent image;
a developer configured to develop the electrostatic latent image with a toner to form a visible image;
a transferor configured to transfer the visible image to a recording medium;
a fixer configured to fix the visible image transferred to the recording medium; and
a cleaner configured to remove the toner remaining on the image bearer,
wherein the lubricant applier includes the lubricant levelling blade according to claim 1.

7. An image forming method, comprising:
applying a lubricant to a surface of an image bearer;
charging the surface of the image bearer;
exposing the image bearer charged to light to form an electrostatic latent image;
developing the electrostatic latent image with a toner to form a visible image;
transferring the visible image to a recording medium;
fixing the visible image transferred to the recording medium; and
removing the toner remaining on the image bearer,
wherein the applying uses the lubricant levelling blade according to claim 1.
